(19) United States
(12) Patent Application Publication
(10) Pub. No.: US 2023/0292313 A1
(43) Pub. Date: Sep. 14, 2023

(54) SYSTEMS AND METHODS OF USING SUPPLEMENTAL UPLINK

(71) Applicant: Meta Platforms Technologies, LLC, Menlo Park, CA (US)

(72) Inventors: Achaleshwar Sahai, San Jose, CA (US); Ping Wang, Redmond, WA (US); Yee Sin Chan, San Francisco, CA (US); Qi Qu, Redmond, WA (US); Kyungho Kim, San Jose, CA (US); Srinivasa Prasad Vangaru, Dublin, CA (US)

(21) Appl. No.: 18/109,601

(22) Filed: Feb. 14, 2023

Related U.S. Application Data
(60) Provisional application No. 63/319,577, filed on Mar. 14, 2022.

(51) Int. Cl. H04W 72/1268; H04W 72/02

(52) U.S. Cl. CPC H04W 72/1268; H04W 72/02

(57) ABSTRACT

Disclosed herein are systems and method for user equipment (UE) based supplemental uplink configuration. A UE can identify, according to a characteristic of the UE for wireless communication, a frequency band for communicating via a supplemental uplink. The UE can transmit, via a transceiver to a base station, a first message comprising an identification of the frequency band and a request to access the frequency band for communicating via the supplemental uplink. The UE can receive, via the transceiver from the base station responsive to the first message, a second message comprising a configuration for the supplemental uplink corresponding to the frequency band. The UE can communicate, via the transceiver, traffic via the supplemental uplink in the frequency band, according to the configuration.

### CROSS-REFERENCE TO RELATED APPLICATION

This application claims the benefit of and priority to U.S. Provisional Patent Application No. 63/319,577, filed on Mar. 14, 2022, the disclosure of which is incorporated herein by reference in its entirety.

### FIELD OF DISCLOSURE

The present disclosure is generally related to facilitating wireless communication, including but not limited to establishing a supplemental uplink for wireless communication.

### BACKGROUND

User equipment (UE) devices, such as smartphones, laptops, augmented reality (AR) or virtual reality (VR) head wearable displays (HWD), can be used for wireless communication with other network devices or services via a cellular, wireless fidelity (Wi-Fi), or other wireless networks. Wireless communication can be implemented in a variety of locations, situations and via any number of network communication protocols.

UE devices implementing artificial reality, such as a VR, AR or, or a mixed reality (MR), can provide a user with an immersive experience. In one example, a user wearing a HWD or smart glasses can turn the user's head, and an image of a virtual object corresponding to a location of the HWD or smart glasses and a gaze direction of the user can be displayed on the HWD or smart glasses to allow the user to feel as if the user is moving within a space of artificial reality (e.g., a VR space, an AR space, or a MR space).

### SUMMARY

This solution is directed to systems and methods for configuration of a supplemental uplink (e.g., uplink communication channel) for communication between a wireless communication device (e.g., UE) and a wireless communication node (e.g., base station) of a wireless communication network, based on capability and/or preference of the wireless communication device. As various UEs can have different characteristics (e.g., internal configuration, device capabilities, prior experience with various frequency bands, or settings or features unique to the device) some UEs can experience different quality of uplink wireless communication when communicating via certain frequency bands as compared to others. As a result, it can be difficult for a base station of a wireless communication network (e.g., 5G system) to provide all types of UEs with reliable and consistent communication uplink, absent input or feedback from the UE. The present solution can overcome this challenge by allowing a UE seeking to establish and use a supplemental uplink for communication, to identify, for a base station of the wireless communication network, a preferred frequency band/channel identified based on the characteristics of the UE. In response to receiving a request for a preferred frequency band from the UE, the base station can provide a response with a configuration of the supplemental uplink communication via the preferred frequency band to the UE. In doing so, the present solution can improve the efficiency and stability of the supplemental uplink communication by accounting for the UE's preferences and internal characteristics when configuring a channel/band for supplemental uplink communication.

In some aspects, the present disclosure relates to a method. The method can include a wireless communication device identifying a frequency band for communicating via a supplemental uplink according to a characteristic of the wireless communication device for wireless communication. The method can include the wireless communication device transmitting to a wireless communication node a first message comprising an identification of the frequency band and a request to access the frequency band for communicating via the supplemental uplink. The method can include the wireless communication device receiving from the wireless communication node, responsive to the first message, a second message comprising a configuration for the supplemental uplink corresponding to the frequency band. The method can include the wireless communication device communicating traffic via the supplemental uplink in the frequency band, according to the configuration.

The method can include the wireless communication device concurrently communicating a first portion of the traffic via the supplemental uplink in the frequency band and a second portion of the traffic via a second uplink in a second frequency band higher than the frequency band. The method can include the wireless communication device determining the characteristic comprising at least one of: a device characteristic/capability of the wireless communication device, a usage characteristic of the wireless communication device, or traffic stored in a buffer of the wireless communication device. The method can include the wireless communication device selecting the frequency band from a plurality of frequency bands according to the characteristic.

The method can include the wireless communication device identifying a plurality of frequency bands as candidates for the supplemental uplink. The method can include performing a ranking of the plurality of frequency bands according to the characteristic. The method can include the wireless communication device identifying the frequency band from the plurality of frequency bands according to the ranking.

The method can include the wireless communication device transmitting, to the wireless communication node, the first message identifying the frequency band and the second frequency band. The method can include the wireless communication device receiving, from the wireless communication node responsive to the first message and in accordance with a network optimization criterion by the wireless communication node, the configuration for the supplemental uplink in accordance with the frequency band.

The method can include the wireless communication device transmitting the first message via a first radio resource control (RRC) message comprising characteristics of the network traffic to be communicated via the supplemental uplink. The method can include the wireless communication device receiving the second message comprising one of a second RRC message or a downlink control information (DCI) message.

The method can include the wireless communication device receiving, from the wireless communication node via one of a radio resource control (RRC) message or a downlink control information (DCI) message, one or more frequency bands supported by the base station. The method can include the wireless communication device selecting, according to the characteristic, the frequency band from the one or more frequency bands.

The method can include the wireless communication device detecting a change in the characteristic of the wireless communication device. The method can include the wireless communication device identifying, responsive to the change, a second frequency band for communicating via the supplemental uplink. The method can include the wireless communication device transmitting, to the wireless communication node, a third message comprising an identification of the second frequency band and a second request to access the second frequency band for communicating via the supplemental uplink. The method can include the wireless communication device receiving, from the wireless communication node responsive to the third message, a fourth message comprising a second configuration for the supplemental uplink wireless communication in accordance with the second frequency band.

The method can include the wireless communication device detecting that an antenna of the wireless communication device has a first efficiency (e.g., antenna transmission efficiency) for the frequency band and a second efficiency for a second frequency band. The method can include the wireless communication device transmitting to the wireless communication node, the first message comprising the request responsive to the first efficiency being greater than the second efficiency.

In some aspects, the present disclosure relates to a wireless communication device. The wireless communication device can include one or more processors. The one or more processors can be configured to identify, according to a characteristic of the wireless communication device for wireless communication, a frequency band for communicating via a supplemental uplink. The one or more processors can be configured to transmit, via a transceiver to a wireless communication node, a first message comprising an identification of the frequency band and a request to access the frequency band for communicating via the supplemental uplink. The one or more processors can be configured to receive, via the transceiver from the wireless communication node responsive to the first message, a second message comprising a configuration for the supplemental uplink corresponding to the frequency band. The one or more processors can be configured to communicate, via the transceiver, traffic via the supplemental uplink in the frequency band, according to the configuration.

The one or more processors can be configured to concurrently communicate, via the transceiver, a first portion of the traffic via the supplemental uplink in the frequency band and a second portion of the traffic via a second uplink in a second frequency band higher than the frequency band. The one or more processors can be configured to determine the characteristic comprising at least one of: a device characteristic of the wireless communication device, a usage characteristic of the wireless communication device, or traffic stored in a buffer of the wireless communication device. The one or more processors can be configured to select the frequency band from a plurality of frequency bands according to the characteristic.

The one or more processors can be configured to identify a plurality of frequency bands as candidates for the supplemental uplink. The one or more processors can be configured to perform a ranking of the plurality of frequency bands according to the characteristic. The one or more processors can be configured to identify the frequency band from the plurality of frequency bands according to the ranking.

The one or more processors can be configured to transmit, via the transceiver to the wireless communication node, the first message identifying the frequency band and the second frequency band. The one or more processors can be configured to receive, via the transceiver from the wireless communication node responsive to the first message and in accordance with a network optimization criterion by the wireless communication node, the configuration for the supplemental uplink in accordance with the frequency band.

The one or more processors can be configured to transmit, via the transceiver, the first message via a first radio resource control (RRC) message comprising characteristics of the network traffic to be communicated via the supplemental uplink. The one or more processors can be configured to receive, via the transceiver, the second message comprising one of a second RRC message or a downlink control information (DCI) message.

The one or more processors can be configured to receive, via the transceiver from the wireless communication node via one of a radio resource control (RRC) message or a downlink control information (DCI) message, one or more frequency bands supported by the base station. The one or more processors can be configured to select, according to the characteristic, the frequency band from the one or more frequency bands.

The one or more processors can be configured to detect a change in the characteristic of the wireless communication device. The one or more processors can be configured to identify, responsive to the change, a second frequency band for communicating via the supplemental uplink. The one or more processors can be configured to transmit, via the transceiver to the wireless communication node, a third message comprising an identification of the second frequency band and a second request to access the second frequency band for communicating via the supplemental uplink. The one or more processors can be configured to receive, via the transceiver from the wireless communication node responsive to the third message, a fourth message comprising a second configuration for the supplemental uplink wireless communication in accordance with the second frequency band.

The one or more processors can be configured to detect that an antenna of the wireless communication device has a first efficiency for the frequency band and a second efficiency for a second frequency band. The one or more processors can be configured to transmit, via the transceiver to the wireless communication node, the first message comprising the request responsive to the first efficiency being greater than the second efficiency.

In some aspects, the present disclosure is related to a non-transitory computer readable medium storing program instructions. The instructions can cause at least one processor of a wireless communication device to identify, according to a characteristic of the wireless communication device for wireless communication, a frequency band for communicating via a supplemental uplink. The instructions can cause at least one processor of a wireless communication device to transmit, via the transceiver to a wireless communication node, a first message comprising an identification of the frequency band and a request to access the frequency band for communicating via the supplemental uplink. The instructions can cause at least one processor of a wireless communication device to receive, via the transceiver from the wireless communication node responsive to the first message, a second message comprising a configuration for the supplemental uplink corresponding to the frequency band. The instructions can cause at least one processor of a wireless communication device to communicate traffic via the supplemental uplink in the frequency band, according to the configuration.

The instructions can cause at least one processor of a wireless communication device to determine the characteristic comprising at least one of: a device characteristic of the wireless communication device, a usage characteristic of the wireless communication device, or traffic stored in a buffer of the wireless communication device. The instructions can cause at least one processor of a wireless communication device to select the frequency band from a plurality of frequency bands according to the characteristic. The instructions can cause at least one processor of a wireless communication device to concurrently communicate, via the transceiver, a first portion of the traffic via the supplemental uplink in the frequency band and a second portion of the traffic via a second uplink in a second frequency band higher than the frequency band.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a block diagram of a system for user equipment based supplemental uplink configuration according to an example implementation of the present disclosure.

FIG. 5 is an example plot of a signal coverage of uplink or downlink signals according to an example implementation of the present disclosure.

FIG. 6 is a flow diagram of an example process of implementing a user equipment based supplemental uplink configuration according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are related to systems and methods for providing a configuration for a supplemental uplink communication based on characteristics (e.g., internal configurations, state of usage or network traffic) of the wireless communication device (e.g., UE). For example, depending on the type of use experienced by a UE (e.g., how the UE is oriented, worn or held by a user), the UE can encounter low coverage or low antenna efficiencies, resulting in a weak uplink signal to the base station. To address this issue, a wireless communication network (e.g., a 5G system or any other cellular network) can provide a supplemental uplink communication to the UE to help improve, support or supplement the uplink communication of the UE. However, as UEs can vary in many ways (e.g., having reduced capabilities, or having different configurations, states or usage), some uplink frequency bands can provide some UEs with a more stable, efficient or reliable wireless communication than other uplink frequency bands. However, as presently there is no solution for allowing UEs to select their preferred uplink frequency bands, it can be difficult for the wireless communication network (e.g., 5G system) to consistently provide the UEs with a reliable and efficient supplemental UL uplink communication service.

The present solution addresses this issue by allowing each UE (e.g., reduced capability devices or wearable devices) to identify, for the wireless communication node (e.g., the base station of the cellular network), one or more preferred/optimal frequency bands for supplemental uplink communication of the UE, that are selected based on the characteristics of the UE. The present solution can allow the base station of the wireless communication network (e.g., 5G system) to receive the requested one or more requested frequency bands (e.g., channels) and can provide to the UE a configuration for the supplemental uplink in accordance with a requested frequency band that is functional and available to the UE at the wireless communication network. In doing so, the present solution can improve the efficiency and stability of the UE's supplemental uplink communication. Also various examples disclosed herein refer to the establishment of supplemental uplinks, the present solution can similarly apply to establishment of any type of uplink or connection.

In one example, the present solution can provide a UE with functionality to identify or select one or more frequency bands for supplemental UL communication of the UE based on the UE's characteristics or prior experience with various supplemental UL bands. The UE can then send to a base station of a 3G/4G/5G/6G system an RRC message identifying and requesting the one or more preferred frequency bands for supplemental UL communication by the UE. The base station can check its network/cell on whether requested one or more frequency bands are available or suitable given the base station's operational or optimization efforts. The base station can then send a configuration for a supplemental UL in accordance with a selected frequency band to the UE. Once the configuration is established, the UE can send communications via the supplemental UL established at the selected frequency band, thereby taking advantage of the UE's internal characteristics with respect to the supplemental UL frequency band(s) to provide a more reliable and efficient performance.

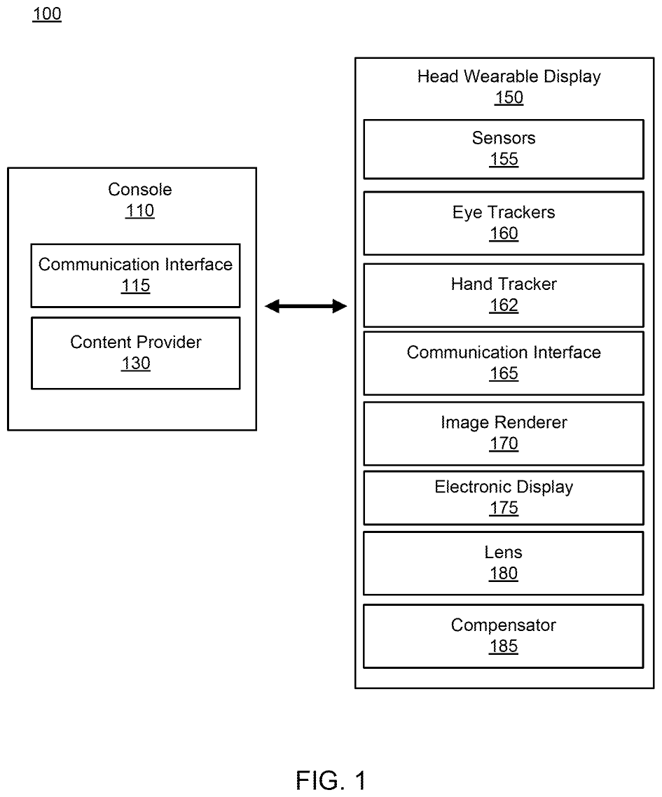

FIG. 1 is a block diagram of an example artificial reality system environment 100. In some embodiments, the artificial reality system environment 100 includes a HWD 150 worn by a user, and a console 110 providing content of artificial reality to the HWD 150. The HWD and/or console may be UEs in a cellular network for instance. The HWD 150 may be referred to as, include, or be part of a head mounted display (HMD), head mounted device (HMD), head wearable device (HWD), head worn display (HWD) or head worn device (HWD). The HWD 150 may detect its location and/or orientation of the HWD 150 as well as a shape, location, and/or an orientation of the body/hand/face of the user, and provide the detected location/or orientation of the HWD 150 and/or tracking information indicating the shape, location, and/or orientation of the body/hand/face to the console 110. The console 110 may generate image data indicating an image of the artificial reality according to the detected location and/or orientation of the HDM 150, the detected shape, location and/or orientation of the body/hand/face of the user, and/or a user input for the artificial reality, and transmit the image data to the HWD 150 for presentation. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150. For example, some of the functionality of the HWD 150 may be performed by the console 110. In some embodiments, the console 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. For example, audio can be presented via an external device (e.g., speakers and/or headphones) that receives audio information from the HWD 150, the console 110, or both, and presents audio based on the audio information. The HWD 150 can include sensors 155, eye trackers 160, a hand tracker 162, a communication interface 165, an image renderer 170, an electronic display 175, a lens 180, and a compensator 185. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detect a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination of them may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gate direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and an orientation of the hand. The hand tracker 162 may generate hand tracking measurements indicating the detected shape, location and orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link. Examples of the wireless link can include a cellular communication link, a near field communication link, Wi-Fi, Bluetooth, 60 GHz wireless link, or any communication wireless communication link. Through the communication link, the communication interface 165 may transmit to the console 110 data indicating the determined location and/or orientation of the HWD 150, the determined gaze direction of the user, and/or hand tracking measurement. Moreover, through the communication link, the communication interface 165 may receive from the console 110 image data indicating or corresponding to an image to be rendered and additional data associated with the image.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, image data describing an image of artificial reality to be rendered and additional data associated with the image, and render the image through the electronic display 175. In some embodiments, the image data from the console 110 may be encoded, and the image renderer 170 may decode the image data to render the image. In some embodiments, the image renderer 170 receives, from the console 110 in additional data, object information indicating virtual objects in the artificial reality space and depth information indicating depth (or distances from the HWD 150) of the virtual objects. In one aspect, according to the image of the artificial reality, object information, depth information from the console 110, and/or updated sensor measurements from the sensors 155, the image renderer 170 may perform shading, reprojection, and/or blending to update the image of the artificial reality to correspond to the updated location and/or orientation of the HWD 150. Assuming that a user rotated his head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality. In some embodiments, the image renderer 170 receives hand model data indicating a shape, a location and an orientation of a hand model corresponding to the hand of the user, and overlay the hand model on the image of the artificial reality. Such hand model may be presented as a visual feedback to allow a user to provide various interactions within the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 150 in a physical space into a virtual space (or simultaneous localization and mapping (SLAM) data), eye tracking data, motion vector information, depth information, edge information, object information, etc. The console 110 may provide the image data and the additional data to the HWD 150 for presentation of the artificial reality. In other embodiments, the console 110 includes more, fewer, or different components than shown in FIG. 1. In some embodiments, the console 110 is integrated as part of the HWD 150.

In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., wireless link). Through the communication link, the communication interface 115 may receive from the HWD 150 data indicating the determined location and/or orientation of the HWD 150, the determined gaze direction of the user, and the hand tracking measurement. Moreover, through the communication link, the communication interface 115 may transmit to the HWD 150 image data describing an image to be rendered and additional data associated with the image of the artificial reality.

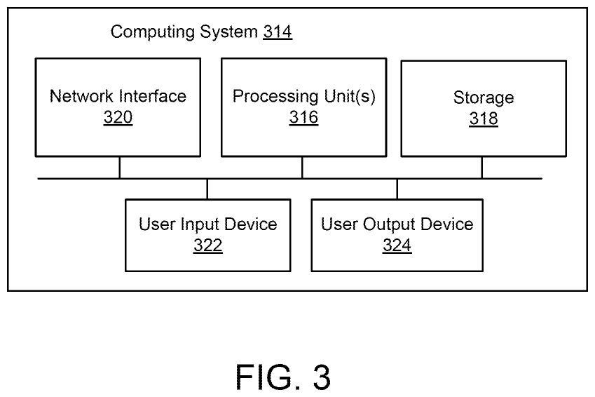

The content provider 130 can include or correspond to a component that generates content to be rendered according to the location and/or orientation of the HWD 150. In some embodiments, the content provider 130 may incorporate the gaze direction of the user of the HWD 150, and a user interaction in the artificial reality based on hand tracking measurements to generate the content to be rendered. In one aspect, the content provider 130 determines a view of the artificial reality according to the location and/or orientation of the HWD 150. For example, the content provider 130 maps the location of the HWD 150 in a physical space to a location within an artificial reality space, and determines a view of the artificial reality space along a direction corresponding to the mapped orientation from the mapped location in the artificial reality space. The content provider 130 may generate image data describing an image of the determined view of the artificial reality space, and transmit the image data to the HWD 150 through the communication interface 115. The content provider 130 may also generate a hand model corresponding to a hand of a user of the HWD 150 according to the hand tracking measurement, and generate hand model data indicating a shape, a location, and an orientation of the hand model in the artificial reality space. In some embodiments, the content provider 130 may generate additional data including motion vector information, depth information, edge information, object information, hand model data, etc., associated with the image, and transmit the additional data together with the image data to the HWD 150 through the communication interface 115. The content provider 130 may encode the image data describing the image, and can transmit the encoded data to the HWD 150. In some embodiments, the content provider 130 generates and provides the image data to the HWD 150 periodically (e.g., every 11 ms). In one aspect, the communication interface 115 can adaptively transmit the additional data to the HWD 150 as described below with respect to FIGS. 3 through 6.

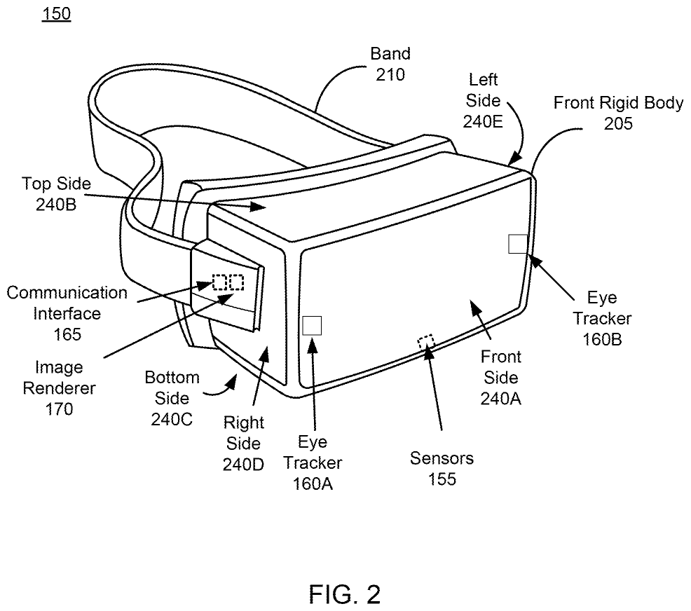

FIG. 2 is a diagram of a HWD 150, in accordance with an example embodiment. In some embodiments, the HWD 150 includes a front rigid body 205 and a head band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the communication interface 165, the image renderer 170, and the sensors 155 are located within the front rigid body 205, and may not visible to the user. In other embodiments, the HWD 150 has a different configuration than shown in FIG. 2. For example, the communication interface 165, the image renderer 170, the eye trackers 160A, 160B, and/or the sensors 155 may be in different locations than shown in FIG. 2.

Various operations described herein can be implemented on computer systems. FIG. 3 shows a block diagram of an example computing system 314 that can be used to implement the present disclosure. In some embodiments, a wireless communication device or a user equipment (e.g., a console 110 or a HWD 150) can be implemented by a computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience, or to implement wireless communication, such as communication over a cellular network (e.g., 4G or 5G network). In some embodiments, the computing system 314 can include conventional computer components such as processors 316, storage device 318, network interface 320, user input device 322, and user output device 324.

Computing system 314 can include one or more processing units 316 (e.g., digital signal processors, microprocessors, system on a chip integrated circuits, media processors, graphics processors, microcontrollers and others). Processing units 316 can include or be coupled with memory, such as read only memory (ROM), random access memory (RAM), static RAM (SRAM), dynamic RAM (DRAM) or flash memory. Memory can store instructions or commands for operating the processors 316.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), memory (e.g., read only memory (ROM), random access memory (RAM), static RAM (SRAM), dynamic RAM (DRAM), flash memory) and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

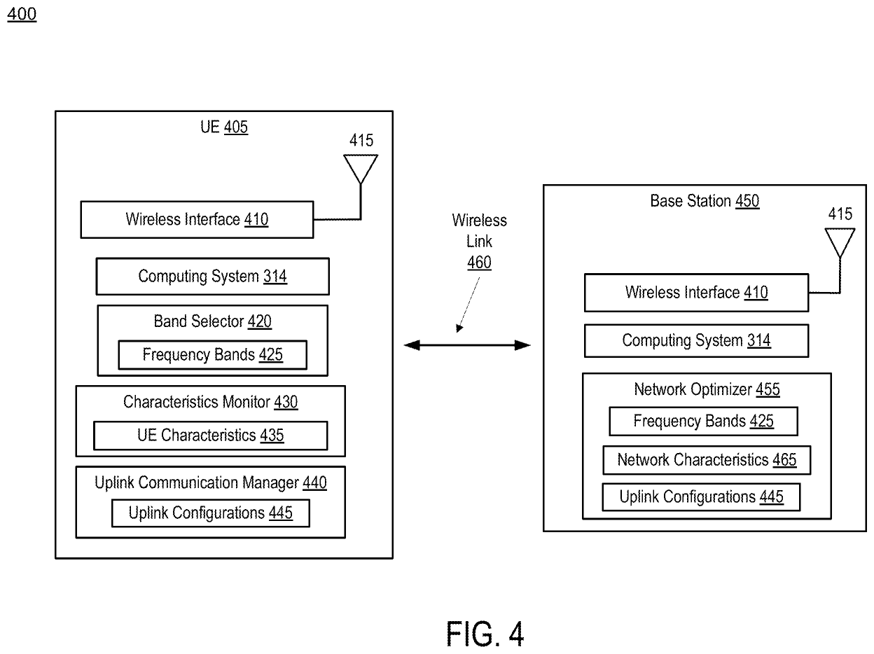

FIG. 4 illustrates an example of a system 400 that can be used to implement a UE based configuration of a supplemental uplink. System 400 can include, for example, a wireless communication device 405, also referred to as user equipment (UE) 405, that can communicate with a remote wireless communication node (e.g., a base station 450) through a wireless communication link 460. A UE 405 can include one or more wireless interfaces 410 that can be coupled with one or more antennas 415. The UE 405 can also include one or more computing systems 314, one or more band selectors 420 that can include one or more frequency bands 425. The UE 405 can further include one or more characteristics monitors 430 that can identify/monitor/detect or include UE characteristics 435, and/or one or more uplink communication managers 440 that can include one or more uplink configurations 445. Base station 450 can include one or more wireless interfaces coupled with one or more antennas 415, one or more computing systems 314, and/or one or more network optimizers 455 that can include frequency bands 425, network characteristics 465 and/or uplink configurations 445.

System 400 can provide a UE 405 with functionality to utilize (e.g., via its computing system 314) a band selector 420 to identify or select frequency bands 425 which UE 405 can use (e.g., prefers to use, has the capability to support, or has improved communication performance when using) for supplemental uplink communication of the UE 405. Frequency bands 425 can be identified by the band selector 420 based on UE characteristics 435 (e.g., architecture or design of antennas 415 resulting in some frequency bands 425 performing at higher efficiency at certain bands/channels than others, orientation, position, or location of the UE 405 preferring some frequency bands 425 over others, or type, pattern or amount of data/traffic communicated by the UE 405). The UE characteristics 435 can be determined by a characteristics monitor 430 monitoring the UE 405. UE 405 can utilize a wireless interface 410 and the antennas 415 to request from a base station 450, via a wireless link 460, a configuration for a supplemental uplink (e.g., different from the wireless link 460) at one or more selected preferred frequency bands 425. For example, a UE 405's request can include multiple frequency bands 425 preferred by the UE 405 or known by the UE 405 to function at an efficiency or reliability exceeding an efficiency or reliability threshold. Base station 450 can utilize a network optimizer 455 to identify a particular frequency band 425 to use from one or more or more frequency bands 425 based on the network characteristics 465 of the base station 450 (e.g., availability or functionality of the requested frequency bands 425 with respect to other ongoing processes at the base station). Base station 450 can send to the UE 405 an uplink configuration 445 corresponding to the requested frequency band 425 to allow a configuration of the uplink communication by the UE 405 at the requested frequency band 425. UE 405 can then use the uplink configuration 445 to send network traffic to the base station 450 via the supplemental uplink communication established via the preferred frequency band 425 (e.g., a lower frequency band that those typically assigned by the base station to UEs).

Base station 450 (also referred to as “wireless communication nodes 450”) can communicate with user equipment 405 (also referred to as “wireless communication device 405”) via a wireless communication link 460 (also referred to as the “wireless link 460”). The wireless link 460 can be a cellular communication link, such as a communication link over 3G, 4G, 5G, 6G or other cellular communication protocols. Wireless link 460 can support, include, employ or otherwise use an orthogonal frequency division multiple access (OFDMA). A UE 405 can be oriented, positioned or located in any orientation, position or within any geographical area or a boundary with respect to the base station 450, and/or worn or held in any way/position relative to a user's body (and such information can be part of a UE's characteristics). UE 405 can communicate with or via the base station 450, with other UEs 405. A plurality of UEs 405 can be in communication with a plurality of base stations 450, forming a radio access network (RAN).

UE 405 can include any electronic device capable of wireless communication. UE 405 can include a user device, such as a mobile phone, a smart phone, a personal digital assistant (PDA), tablet, laptop computer, wearable computing device (e.g., head mounted display, smart glasses, smart watch), etc. UE 405 can communicate with the base station 450 through any number of wireless links 460, utilizing any wireless communication configurations or protocols (e.g., 3G, 4G, 5G, 6G or other cellular communication). UE 405 and base station 450 can exchange audio data, video data, image data, text, commands, instructions, etc. Communication or transmission of data by the UE 405 to the base station 450 may be referred to as an uplink communication. Communication or reception of data to the UE 405 from the base station 450 may be referred to as a downlink communication.

Because the base station 450 can have more power than a UE 405 (e.g., smartphone), downlink communication can have more power and greater range or coverage than the uplink communication. To improve the range of the uplink communication from the UE 405, a supplemental uplink can be established (e.g., to supplement or replace another uplink or connection/channel). The supplemental uplink (or supplemental connection/channel) can be implemented at a lower frequency than the original or baseline uplink. For example, if uplink communication is established at 3 GHz frequency, a supplemental uplink communication by the UE 405 can be established at 1.8 GHz to potentially provide greater coverage or range (and/or lower interference, bit error rate, etc.) for the UE. UE 405 can simultaneously communicate with the base station 450 via an (original) uplink communication channel at a first frequency band 425A and via the supplemental uplink (communication channel) at a second frequency band 425B.

Base station 450 can be or include an evolved node B (eNB), a gNodeB, a femto station, or a pico station. Base station 450 can be communicatively coupled to another base station 450 or other communication devices through a wireless communication link (e.g., another wireless link 460) and/or a wired communication link. Base station 450 can receive data (or a RF signal) in an uplink communication from a UE 405. Additionally or alternatively, base station 450 can provide data to another UE 405, another base station 450, or any other communication device. Hence, base station 450 can allow communication among UEs 405 associated with the base station 450, or other UEs 405 associated with different base stations 450.

Both the UE 405 and base station 450 can include a wireless interface 410, a computing system 314 and one or more antennas 415. Wireless interfaces 410, computing systems 314 and antennas 415 can each be embodied as a combination of hardware and software and can be integrated to provide network communication (e.g., downlink and uplink communication). For example, UE 405 can include includes more, fewer, or different components than shown in FIG. 4. For example, the UE 405 can include an electronic display and/or an input device, additional antennas 415 or wireless interfaces 410 than shown in FIG. 2.

Antenna 415 can include a component that receives a radio frequency (RF) signal and/or transmits a RF signal through a wireless medium. The RF signal can be received or transmitted at a frequency between 200 MHz to 100 GHz for example. The RF signal may have packets, symbols, or frames corresponding to data for communication. The antenna 415 can be a dipole antenna, a patch antenna, a ring antenna, an antenna array or any suitable antenna for wireless communication. In one aspect, a single antenna 415 can be utilized for both transmitting a RF signal and receiving a RF signal. In one aspect, different antennas 415 can be utilized for transmitting the RF signal and receiving the RF signal. In one aspect, multiple antennas 415 are utilized to support multiple-in, multiple-out (MIMO) communication.

Wireless interface 410 (included in a UE 405 or base station 450) can include or be embodied as a transceiver for transmitting and receiving RF signals through one or more antennas 415. For example, a wireless interface 410 of the UE 405 can use an antenna 415 of the UE 405 to communicate with an antenna 415 and the wireless interface 410 of the base station 450 through a wireless link 460, and vice versa. Wireless interface 410 of a system or a device (e.g., UE 405 or base station 450) can be coupled to one or more antennas 415 and receive the RF signal at the RF frequency received through an antenna 415. Wireless interface 410 can include the circuitry to downconvert the RF signal to a baseband frequency (e.g., 0-1 GHz). Wireless interface 415 can include the circuitry to provide the downconverted signal to the processor 316 of the computing system 314. Wireless interface 410 can receive a baseband signal for transmission at a baseband frequency from the processor 316, and upconvert the baseband signal to generate a RF signal. Wireless interface 410 can transmit the RF signal through the antenna 415 to the receiving device (e.g., base station 450, UE 405 or any other device).

Computing system 314 (on the UE 405 or base station 450) can include processors 316 for processing data and implementing the functionality of the present solution (e.g., band selector 420, characteristics monitor 430, uplink communication manager 440 and network optimizer 455). Processors 316 can be embodied as field programmable gate array (FPGA), application specific integrated circuit (ASIC), a logic circuit, etc. Processors 316 can be coupled with or include memory for information storage (e.g., SRAM, DRAM or cache memory) that can store instructions which the processors 316 can obtain and execute. In one aspect, processor 316 can receive downconverted data at the baseband frequency from the wireless interface 410, and decode or process the downconverted data. For example, the processor 316 can generate audio data or image data according to the downconverted data, and present an audio indicated by the audio data and/or an image indicated by the image data to a user of the UE 405. In one aspect, the processor 316 can generate or obtain data for transmission at the baseband frequency, and encode or process the data. For example, processor 316 can encode or process image data or audio data at the baseband frequency, and provide the encoded or processed data to the wireless interface 410 for transmission.

Computing system 314 can include memory devices embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory devices can be embodied as a non-transitory computer readable medium storing instructions executable by the processor 316 to perform various functions of the UE 405 disclosed herein.

Frequency band 425 can include any range of frequencies in which wireless communication can be implemented between the UE 405 and a base station 450. A frequency band 425 can include a particular frequency range corresponding to one or more channels. Frequency band 425 can include, for example, communication bands corresponding to channels or bands of cellular networks operating at 3G, 4G LTE, 5G, 6G, or any other communication protocol or standard. Frequency band 425 can include a subset of frequencies between about 400 MHz and about 2.5 GHz. For example, a frequency band 425 can include any frequency range, such as 1920-1980 MHz, 1850-1910 MHz, 1710-1785 MHz, 824-849 MHz, 880-915 MHz, 1427-1447 MHz, 663-698 MHz, 461-466 MHz or 2305-2315 MHz.

UE characteristics 435 can include any characteristics, configurations, features, states, orientations, positions or locations of the UE 405 that can result in one frequency band 425 being preferred (e.g., more effectively supported/usable) by the UE 405 than other frequency band 425. UE characteristics 435 can include an internal configuration of the UE 405. For example, UE characteristic 435 can include an antenna 415 architecture or wireless interface 410 configurations, including for example the performance of upconversion or a downconversion circuitry architecture, or any feature of the UE 405 that results in a wireless communication at one frequency band 425 having higher performance than a wireless communication at another frequency band 425. UE characteristic 435 can include information or data on antenna/transmission efficiency with respect to a particular frequency band 425, based on the efficiency determination or measurement by the UE 405 during a prior usage of the particular frequency band 425.

UE characteristics 435 can include information or data on a dynamic state of the UE 405. For example, a UE 405 can employ one or more sensors that can perform one or more measurements to determine orientation, position or location of the UE 405. For example, UE characteristic 435 can include an orientation (e.g., tilt, yaw) of a UE 405 with respect to a reference point, a global positioning system (GPS) location of the UE 405 or a position of the UE 405 with respect to another device, or a structure (e.g., building). UE characteristic 435 can include information on the movement of the UE 405 (e.g., velocity at which UE 405 is moving and direction at which it is moving). UE characteristic 435 can include information about how the UE is held or worn or placed (relative to a body part or other object/obstruction) which can block or affect the transmission effectiveness/efficiency of particular antennas for instance.

UE characteristic 435 can include data or information on dynamic characteristics or usage of the UE 405. For example, UE characteristic 435 can include information on type of application that UE 405 is utilizing, or type of data (e.g., amount of data, data rate, latency requirements) for which the UE 405 is going to utilize the uplink communication. UE characteristic 435 can include information or data on the amount of traffic in a buffer/queue, a rate of network traffic being sent by the UE 405 or being received by the UE 405, and/or traffic pattern of the traffic which can be bursty or continuous for instance. UE characteristic 435 can include a determination or estimate of the expected amount of traffic flow (e.g., based on the applications being executed and prior data on the traffic flow when the same applications were previously used).

Characteristics monitor 430 can include any combination of hardware and software for identifying, determining, detecting and monitoring any UE characteristic 435. Characteristics monitor 430 can monitor operation or performance of the antenna 415 or wireless interface 410 with respect to one or more frequency bands 425. Characteristics monitor 430 can detect, identify or monitor performance and data rates of applications executing on the UE 405, data buffers of the UE 405, and positions, locations and usage of the UE 405. Characteristics monitor 430 can detect, identify or monitor efficiency, speed, strength, reliability and any other statistic or a determination corresponding to signals sent or received by the UE 405 with respect to any frequency band 425.

Band selector 420 can include any combination of hardware and software for selecting frequency bands 425 for a particular wireless communication between a UE 405 and base station 450. Band selector 420 can include the functionality for selecting or identifying one or more frequency bands 425 for an uplink communication between a UE 405 and base station 450, such as an original or main uplink. Band selector 420 can select a frequency band 425 for a supplemental uplink (e.g., to aggregate with the original uplink) in order to increase the quality, efficiency and/or range of the uplink communication.

Band selector 420 can select the frequency bands 425 based on UE characteristics 435 selected by the characteristics monitor 430. For example, band selector 420 can rank the performance of transmissions (e.g., sent or received data) at any frequency band 425. Band selector 420 can rank frequency bands 425 based on the performance of the signal (e.g., efficiency, strength, reliability or bandwidth) with respect to the transmissions at any of the frequency bands 425. Band selector 420 can select the band based on prior data or usage of that particular frequency band 425 with respect to a particular application that the UE 405 is using, a particular location the UE 405 is accessing, a type of usage (e.g., UE 405 in a moving vehicle or UE 405 being used to play a video game or send or receive real-time data). Band selector 420 can select a single frequency band 425 for uplink communication or can select a plurality of frequency bands 425, which can be ordered or ranked based on their preference.

Uplink communication manager 440 can include any combination of hardware and software for establishing and managing wireless communication. Uplink communication manager 440 can generate and send requests to a base station 450 identifying selected frequency bands 425. Uplink communication manager 440 can receive responses from the base station 450. Uplink communication manager 440 can receive uplink configurations 445 for configuring, establishing or otherwise implementing an uplink/channel at a frequency band 425 determined, provided or approved by the base station 450.

Uplink configurations 445 can include any information or data for establishing, confirming or otherwise creating an uplink (e.g., uplink channel/connection) for wireless communication between the UE 405 and base station 450. Uplink configuration 445 can include instructions, data or information for establishing an uplink between a UE 405 and base station 450. For example, uplink configuration 445 can include an initial or original uplink (or uplink channel) between UE 405 and base station 450, identifying the frequency band 425 for the initial or original uplink. For example, uplink configuration 445 can include a supplemental uplink between UE 405 and base station 450, identifying the frequency band 425 for the supplemental uplink.

Network characteristics 465 can include any characteristics of the base station 450 or the wireless communication network of the base station 450 (e.g., 4G system or 5G system). Network characteristics 465 can identify frequency bands 425 that are unavailable to UEs 405 and frequency bands 425 that are available to UEs 405. Network characteristics 465 can include information or data on network capabilities or resources with respect to configuration of uplink communication by UEs 405 communicating with the base station 450. Network characteristics 465 can include information or data that a particular frequency band 425 is unavailable or not desirable for the base station 450 or that a particular frequency band 425 is desirable and available. For example, a desirable frequency band 425 can include a frequency band 425 providing better performance than other frequency bands 425 (e.g., improved bandwidth, reliability, range, signal strength, signal to noise ratio).

Network optimizer 455 can include any function improving or optimizing operation of the base station 450. Network optimizer 455 can consider network characteristics 465 when assigning frequency bands 425 to UEs 405. Network optimizer 455 can mark or identify one or more frequency bands 425 as undesirable, sub-optimal or unavailable in response to determining that communication via such frequency bands 425 corresponds to poor performance (e.g., reduced efficiency, speed, bandwidth, range or reliability of the received signal). Network optimizer 455 can receive requests from uplink communication managers 440 along with requested frequency bands 425.

Network optimizer 455 can determine, based on the network characteristics 465, whether to provide uplink configurations 445 to the requesting UEs 405 based on the requested frequency bands 425 or some other frequency bands 425. For example, when network optimizer 455 determines, based on network characteristics 465, that a requested frequency band 425 (e.g., from a UE 405) is not undesirable or unavailable, base station 450 can send an uplink configuration 445 in accordance with the requested frequency band 425. For example, when network optimizer 455 determines, based on network characteristics 465, that a requested frequency band 425 (e.g., from a UE 405) is undesirable or unavailable, base station 450 can send an uplink configuration 445 in accordance with a different requested frequency band 425 than the one requested. For example, when network optimizer 455 determines, based on network characteristics 465, that a first requested frequency band 425 (e.g., from a UE 405) is undesirable or unavailable but a second requested frequency band 425 is not undesirable or unavailable, base station 450 can send an uplink configuration 445 in accordance with a second requested frequency band 425 and not the first requested frequency band 425.

In some aspects, the present solution relates to a wireless communication device (e.g., UE 405) that can include one or more processors 316. The one or more processors 316 can be configured to identify or select a frequency band 425 for communicating via a supplemental uplink. The frequency band 425 can be selected or identified according to one or more UE characteristics 435 of the wireless communication device 405. The one or more UE characteristics 435 can include characteristics of the UE 405 corresponding to the wireless communication.

For example, UE characteristics 435 can include internal configurations/capabilities or architecture of the UE 405 (e.g., design or type of antenna 415 or features of the wireless interface 410 that can be more suitable for operation at some frequency bands 425 than others). UE characteristics 435 can include orientation/position/location of the UE 405 with respect to the base station 450 or surrounding structures or devices (e.g., GPS locations of the UE 405, orientation or angles at which the UE 405 is turned or used, or location of the UE 405 with respect to surrounding structures that can affect communication at some frequency bands 425). UE characteristics 435 can include dynamic state of the UE 405 (e.g., whether certain antennas of the UE are blocked or operational, how and where the UE 405 is being used, the speed at which the UE 405 is travelling, or direction towards which the UE 405 is moving). UE characteristics 435 can include information on amount or type of network traffic in the buffer or queue at the UE 405 as well as applications on the UE 405 being used by the UE 405, which can be indicative of the amount or type of traffic expected to be communicated by UE 405.

Once one or more frequency bands 425 are selected, the one or more processors 316 can transmit, via a transceiver of the wireless interface 410 to a wireless communication node (e.g., base station 450), a first message. The first message can include an identification of the frequency band 425. The first message can include a request to access the frequency band 425 for communicating via the supplemental uplink. For example, the first message can include a request to establish a supplemental UL communication at the selected one or more frequency bands 425.

The one or more processors 316 can receive, via the transceiver of the wireless interface 410, from the wireless communication node (e.g., base station 450), a second message comprising an uplink configuration 445 for the supplemental uplink corresponding to the frequency band 425. The second message can be received in response to the transmission of the first message. The second message can include instructions, commands or data for the UE 405 to implement one or more steps in configuring the supplemental UL configuration at the frequency band 425 identified in the second message.

Once the supplemental UL is configured or established, the one or more processors 316 can communicate, via the transceiver of the wireless interface 410, traffic via the supplemental uplink in the frequency band 425, according to the uplink configuration 445. UE 405 can communicate data with the base station 450 using both a default uplink at a frequency band 425 determined by the base station 450 earlier (e.g., at the start of the communication between the UE 405 and the BS 450) and also via the supplemental uplink established at the frequency band 425 requested by the UE 405.

For example, the one or more processors 316 can be configured to concurrently communicate, via the transceiver of the wireless interface 410, a first portion of the traffic via the supplemental uplink in the frequency band 425 and a second portion of the traffic via a second uplink in a second frequency band 425 higher than the frequency band 425. The second uplink can include the default uplink established by the BS 450 at the start of the communication between the UE 405 and the BS 450. The second uplink can be at a second frequency band 425 determined by the BS 450 and assigned to the UE 405 by the BS 450. The second frequency band 425 of the default uplink can be at a higher frequency than the frequency band 425 for the supplemental uplink. The second frequency band 425 of the default uplink can be at a lower frequency than the frequency band 425 for the supplemental uplink.

The one or more processors 316 can be configured to determine the characteristic comprising at least one of: a device characteristic of the wireless communication device, a usage characteristic of the wireless communication device, or traffic stored in a buffer of the wireless communication device. The device characteristic can include hardware features/capabilities/limitations concerning a wireless interface 410, a transceiver of the wireless interface 410 and/or antenna 415. The usage characteristic can for example include information on types of application used by the UE 405 and type or amount of data expected from the application. The one or more processors 316 can be configured to select the frequency band from a plurality of frequency bands according to the characteristic.

The one or more processors 316 can be configured to identify a plurality of frequency bands as candidates for the supplemental uplink. The one or more processors 316 can be configured to perform a ranking of the plurality of frequency bands according to the characteristic. The one or more processors 316 can be configured to identify the frequency band from the plurality of frequency bands according to the ranking.

The one or more processors 316 can be configured to transmit, via the transceiver (e.g., a part of wireless interface 410) to the wireless communication node 450, the first message identifying the frequency band 425 and the second frequency band 425. The one or more processors 316 can be configured to receive, via the transceiver 410 from the wireless communication node 450 responsive to the first message and in accordance with a network optimization criterion (e.g., in relation to network characteristics 465) by the wireless communication node 450, the configuration (e.g., 445) for the supplemental uplink in accordance with the frequency band 425.

The one or more processors 316 can be configured to transmit, via the transceiver 410, the first message via a first radio resource control (RRC) message comprising UE characteristics 435 of the network traffic to be communicated via the supplemental uplink. The one or more processors 316 can be configured to receive, via the transceiver 410, the second message comprising one of a second RRC message or a downlink control information (DCI) message. For example, the BS 450 can send the second message via RCC or DCI to provide the uplink configuration 445 to the UE 405.

The one or more processors 316 can be configured to receive, via the transceiver 410 from the wireless communication node 450 via one of a radio resource control (RRC) message or a downlink control information (DCI) message, one or more frequency bands 425 supported by the wireless communication node 450. The one or more processors 316 can be configured to select, according to the UE characteristic 435, the frequency band 425 from the one or more frequency bands 425. For example, UE 405 can select, from a plurality of frequency bands 425 of which the UE 405 has prior knowledge or experience (e.g., reliability, efficiency, bandwidth) a particular frequency band 425 with highest reliability, efficiency or bandwidth.

The one or more processors 316 can be configured to detect a change in the UE characteristic 435 of the wireless communication device 405. For example, efficiency of the supplemental UL communication can be reduced, or a new application can be used by the user of the UE 405. The one or more processors 316 can be configured to identify, responsive to the change, a second frequency band 425 for communicating via the supplemental uplink. The one or more processors 316 can be configured to transmit, via the transceiver 410 to the wireless communication node 450, a third message comprising an identification of the second frequency 425 band. The third message can include a second request to access the second frequency band 425 for communicating via the supplemental uplink. The one or more processors 316 can be configured to receive, via the transceiver 410 from the wireless communication node 450 responsive to the third message, a fourth message comprising a second uplink configuration 445 for the supplemental uplink wireless communication in accordance with the second frequency band 425.

The one or more processors 316 can be configured to detect that an antenna 415 of the wireless communication device 405 has a first efficiency for the frequency band 425 and a second efficiency for a second frequency band 425. The first efficiency can be greater than the second efficiency. The efficiency can be measured based on the signal strength. The one or more processors 316 can be configured to transmit, via the transceiver 410 to the wireless communication node 450, the first message comprising the request responsive to the first efficiency being greater than the second efficiency.

In some aspects, the present solution is directed to a non-transitory computer readable medium storing program instructions. The instructions can cause at least one processor 316 of a wireless communication device 405 to identify, according to a UE characteristic 435 of the wireless communication device 405 for wireless communication, a frequency band 425 for communicating via a supplemental uplink. The instructions can cause at least one processor 316 of a wireless communication device 405 to transmit, via the transceiver (e.g., wireless interface 410) to a wireless communication node 450, a first message comprising an identification of the frequency band 425 and a request to access the frequency band 425 for communicating via the supplemental uplink. The instructions can cause at least one processor 316 of a wireless communication device 405 to receive, via the transceiver 410 from the wireless communication node responsive to the first message, a second message. The second message can include a uplink configuration 445 for the supplemental uplink corresponding to the frequency band 425. The instructions can cause at least one processor 316 of a wireless communication device 405 to communicate traffic via the supplemental uplink in the frequency band 425, according to the uplink configuration 445.

The instructions can cause at least one processor 316 of a wireless communication device 405 to determine the UE characteristic 435 comprising at least one of: a device characteristic of the wireless communication device, a usage characteristic of the wireless communication device, or traffic stored in a buffer of the wireless communication device. The instructions can cause at least one processor 316 of a wireless communication device 405 to select the frequency band 425 from a plurality of frequency bands 425 according to the UE characteristic 435. The instructions can cause at least one processor 316 of a wireless communication device 405 to concurrently communicate, via the transceiver (e.g., wireless interface 410), a first portion of the traffic via the supplemental uplink in the frequency band 425 and a second portion of the traffic via a second uplink in a second frequency band 425 higher than the frequency band 425.

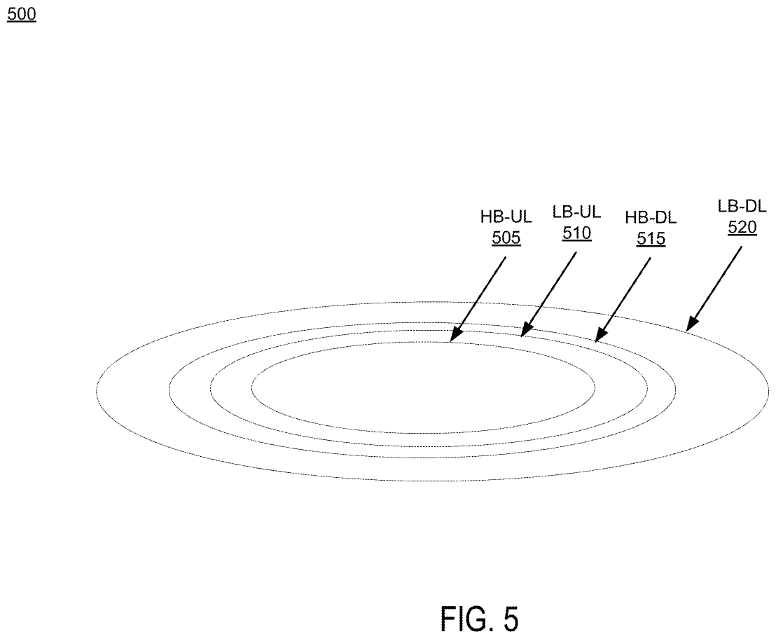

FIG. 5 provides an example of signal coverage 500 in the context of band aggregation or pairing. In an example, signal coverage 500 can include a high-band (HB) uplink (UL) 505 frequency band, also referred to as HB-UL 505 band, which can cover an area that is included within a larger area covered by a low-band (LB) UL 510 frequency band, also referred to as LB-UL 510 band. The LB-UL 510 band can cover an area that is encompassed or included within a larger area covered by a HB downlink (DL) 515 band, also referred to as HB-DL 515 band, which can be further encompassed or included within an area covered by a LB-DL 520 band. Each of the HB-UL 505, LB-UL 510, HB-DL 515 and LB-DL 520 bands can be, or correspond to, individual frequency bands 425 at different frequency ranges and covering a different signal range or signal area.

Depending on network configurations, situations or UEs 405 utilized, uplink (UL) frequency bands 425 and/or downlink (DL) frequency bands 425 can be paired or aggregated. For example, HB-DL 515 band can be paired/suplemented with another HB-DL 515 band (e.g., at another frequency range or channel) to provide added signal strength and reliability. For example, a supplemental link (UL and/or DL) can be provided or added in the form of an additional UL/DL frequency band 425 to supplement a default UL/DL frequency band 425 already formed.

In an example, a supplemental UL may include a DL frequency band 425 in a higher frequency range or band and a UL frequency band 425 in a lower frequency range or band. In such a configuration, packet loss occurrence in the lower frequency band can be reduced, and the UL coverage may be improved due to the lower frequency of the supplemental UL frequency band 425. Because a base station (BS) 450 may transmit at higher power than the UE 405, the signal of the BS 450 can be more likely to reach the UE 405 such that DL coverage from the BS 450 is not lost, reduced or sacrificed.

Frequency bands 425 at higher frequencies (e.g., frequency bands 425 operating at about 2000 MHz or above) can have their uplink coverage limited due to signal attenuation at higher frequencies. Frequency bands 425 at lower frequencies (e.g., under 1000 MHz) can have their available bandwidth for communication limited. For example, in the instances in which the communication involves large transmissions of DL data, it may be preferable to have DL frequency bands 425 that are lightly loaded and large bandwidth, while having UL frequency bands 425 providing adequate coverage even if at lower bandwidth for the UL communication.

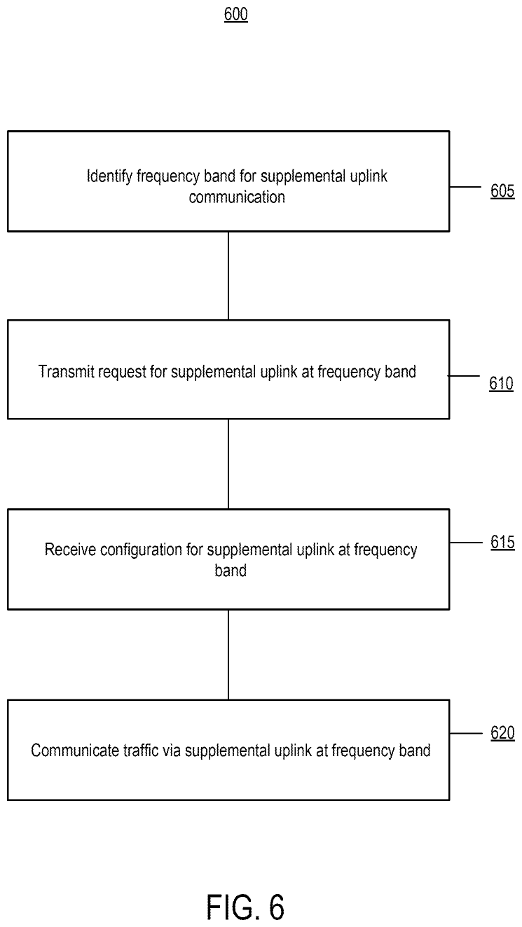

FIG. 6 illustrates an example flowchart of a method 600 of implementing a user equipment based supplemental uplink configuration. Method 600 can be implemented by a system, such as the system 400 described in connection with FIG. 4. The method can include ACTS 605-620. At ACT 605, the method can identify a frequency band for a supplemental uplink communication. At ACT 610, the method can transmit a request for the supplemental uplink at the frequency band. At ACT 615, the method can receive configuration for supplemental uplink at the frequency band. At ACT 620, the method can communicate traffic via the supplemental uplink at the frequency band.

At ACT 605, the method can identify a frequency band for a supplemental uplink. The method can include a wireless communication device identifying a frequency band for communicating via a supplemental uplink according to a characteristic of the wireless communication device for wireless communication. The characteristic can include internal configurations or architecture of the wireless communication device (e.g., UE), including for example, design or type of antenna or features of the wireless interface (e.g., transceiver) which can be more suitable for operation one frequency band more than at another frequency band. The characteristic can include orientation, position, location of the wireless communication device with respect to the wireless communication node (e.g., base station) or surrounding structures or devices (e.g., GPS locations of the device, orientation or angles at which the device is turned or used, or location of the device with respect to surrounding structures that can affect communication at some frequency bands more than at other frequency bands). The characteristic can include dynamic state of the wireless communication device (e.g., how and where the device is being used/held/worn, the speed at which the device moves, or direction towards which the device is moving). The characteristic can include information on amount or type of network traffic in the buffer or queue at the device, as well as applications on the device being used, which can be indicative of the amount or type of traffic expected to be communicated by device.

The method can include the wireless communication device determining the characteristic comprising at least one of: a device characteristic of the wireless communication device, a usage characteristic of the wireless communication device, or estimated/projected traffic or traffic pattern (e.g., based on traffic stored in a buffer of the wireless communication device). The device characteristic can include a capability of the wireless communication device, or an architecture of one or more antennas of the device or circuitry of the transceiver or wireless interface, for instance. Usage characteristics can include position or orientation of the device, aspects impairing transmission/antenna operation, or an application that operates at the device, for example.

The method can include the wireless communication device selecting the frequency band from a plurality of frequency bands according to the characteristic. For example, the method can include the wireless communication device identifying a plurality of frequency bands as candidates for the supplemental uplink. The method can include the wireless communication device performing a ranking of the plurality of frequency bands according to the characteristic. The method can include the wireless communication device identifying/selecting the frequency band from the plurality of frequency bands according to the ranking.

The method can include the wireless communication device receiving from the wireless communication node, via a message (e.g., via one of a radio resource control (RRC) message or a downlink control information (DCI) message), one or more frequency bands supported by the base station. The RRC or DCI message can include a list of available or functional frequency bands suggested by the base station. The method can include the wireless communication device selecting according to the characteristic, the frequency band from the one or more frequency bands.

At ACT 610, the method can transmit a request for the supplemental uplink at the frequency band. The method can include the wireless communication device transmitting, to a wireless communication node, a first message comprising an identification of the frequency band, e.g., for the supplemental uplink. The first message can include a request to access the frequency band for communicating via the supplemental uplink. The first message can include a plurality of frequency bands requested by the wireless communication device (e.g., UE). The first message can be sent to the wireless communication node (e.g., base station) in response to identifying, by the wireless communication device (e.g., UE), one or more frequency bands to use for supplemental uplink communication.

The method can include the wireless communication device transmitting, to the wireless communication node, the first message identifying the frequency band and a second frequency band. The method can include the wireless communication device transmitting the first message via a first radio resource control (RRC) message comprising characteristics of the network traffic to be communicated via the supplemental uplink. For example, the first message can include information on the type of data to be sent (e.g., instructions, media data, audio or video data, real-time transmissions, data sensitive to latencies or not sensitive to latencies). For example, the first message can include information on the type of application being used by the wireless communication device (e.g., AR/VR application, data streaming application, video application, application associated with high bandwidth demand, application associated with high transmission rates, or application associated with data transmissions sensitive to latencies).

At ACT 615, the method can receive a configuration for the supplemental uplink at the frequency band. The method can include the wireless communication device receiving a second message. The second message can be received from the wireless communication node (e.g., base station) responsive to the first message. The second message can include an uplink configuration for configuring or establishing the supplemental uplink corresponding to the frequency band. The method can include the wireless communication device receiving the configuration for the supplemental uplink in accordance with the frequency band. The configuration can be received from the wireless communication node (e.g., base station), responsive to the first message. The configuration can be determined/selected/received in accordance with a network optimization criterion (e.g., network characteristic) of the wireless communication node (e.g., base station).

The method can include the wireless communication device receiving the second message, the second message for example comprising one of a second RRC message or a downlink control information (DCI) message. The method can include the wireless communication device detecting that an antenna of the wireless communication device has a first efficiency for the frequency band and a second efficiency for a second frequency band. The method can include the wireless communication device transmitting to the wireless communication node the first message comprising the request (e.g., for establishing the supplemental uplink to use the first frequency band) responsive to the first efficiency being greater than the second efficiency.

At ACT 620, the method can communicate traffic via the supplemental uplink at the frequency band. The method can include the wireless communication device communicating traffic via the supplemental uplink in the frequency band, according to the configuration. For example, the wireless communication device can concurrently communicate a first portion of the traffic via the supplemental uplink in the frequency band and a second portion of the traffic via a second uplink (e.g., main, default, standard or original uplink) in a second frequency band. The second frequency band can be higher than the frequency band. The second frequency band can correspond to a default uplink communication band or channel established by the base station. The frequency band can be used as a supplemental to the second frequency band, for uplink transmissions for instance.

The method can include the wireless communication device detecting a change in the characteristic of the wireless communication device. The method can include the wireless communication device identifying, responsive to the change, a second frequency band for communicating via the supplemental uplink. The method can include the wireless communication device transmitting, to the wireless communication node, a third message comprising: an identification of the second frequency band and a request to access the second frequency band for communicating via the supplemental uplink. The method can include the wireless communication device receiving, from the wireless communication node responsive to the third message, a fourth message comprising a second configuration for the supplemental uplink wireless communication in accordance with the second frequency band.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
identifying, by a wireless communication device, a frequency band for communicating via a supplemental uplink according to a characteristic of the wireless communication device for wireless communication;
transmitting, by the wireless communication device to a wireless communication node, a first message comprising an identification of the frequency band and a request to access the frequency band for communicating via the supplemental uplink;
receiving, by the wireless communication device from the wireless communication node responsive to the first message, a second message comprising a configuration for the supplemental uplink corresponding to the frequency band; and
communicating, by the wireless communication device, traffic via the supplemental uplink in the frequency band, according to the configuration.

2. The method of claim 1, comprising:
concurrently communicating, by the wireless communication device, a first portion of the traffic via the supplemental uplink in the frequency band and a second portion of the traffic via a second uplink in a second frequency band higher than the frequency band.

3. The method of claim 1, comprising:
determining, by the wireless communication device, the characteristic comprising at least one of: a device characteristic of the wireless communication device, a usage characteristic of the wireless communication device, or traffic stored in a buffer of the wireless communication device; and
selecting, by the wireless communication device, the frequency band from a plurality of frequency bands according to the characteristic.

4. The method of claim 1, comprising:
identifying, by the wireless communication device, a plurality of frequency bands as candidates for the supplemental uplink;
performing, by the wireless communication device, a ranking of the plurality of frequency bands according to the characteristic; and
identifying, by the wireless communication device, the frequency band from the plurality of frequency bands according to the ranking.

5. The method of claim 1, comprising:
transmitting, by the wireless communication device to the wireless communication node, the first message identifying the frequency band and the second frequency band; and
receiving, by the wireless communication device from the wireless communication node responsive to the first message and in accordance with a network optimization criterion by the wireless communication node, the configuration for the supplemental uplink in accordance with the frequency band.

6. The method of claim 1, comprising:
transmitting, by the wireless communication device, the first message via a first radio resource control (RRC) message comprising characteristics of the network traffic to be communicated via the supplemental uplink; and
receiving, by the wireless communication device, the second message comprising one of a second RRC message or a downlink control information (DCI) message.

7. The method of claim 1, comprising:
receiving, by the wireless communication device, from the wireless communication node via one of a radio resource control (RRC) message or a downlink control information (DCI) message, one or more frequency bands supported by the wireless communication node; and
selecting, by the wireless communication device, according to the characteristic, the frequency band from the one or more frequency bands.

8. The method of claim 1, comprising:
detecting, by the wireless communication device, a change in the characteristic of the wireless communication device;
identifying, by the wireless communication device responsive to the change, a second frequency band for communicating via the supplemental uplink;
transmitting, by the wireless communication device to the wireless communication node, a third message comprising an identification of the second frequency band and a second request to access the second frequency band for communicating via the supplemental uplink; and
receiving, by the wireless communication device from the wireless communication node responsive to the third message, a fourth message comprising a second configuration for the supplemental uplink wireless communication in accordance with the second frequency band.

9. The method of claim 1, comprising:
detecting, by the wireless communication device, that an antenna of the wireless communication device has a first efficiency for the frequency band and a second efficiency for a second frequency band; and
transmitting, by the wireless communication device, to the wireless communication node, the first message comprising the request responsive to the first efficiency being greater than the second efficiency.

10. A wireless communication device, comprising:
one or more processors configured to:
identify, according to a characteristic of the wireless communication device for wireless communication, a frequency band for communicating via a supplemental uplink;
transmit, via a transceiver to a wireless communication node, a first message comprising an identification of the frequency band and a request to access the frequency band for communicating via the supplemental uplink;
receive, via the transceiver from the wireless communication node responsive to the first message, a second message comprising a configuration for the supplemental uplink corresponding to the frequency band; and
communicate, via the transceiver, traffic via the supplemental uplink in the frequency band, according to the configuration.

11. The system of claim 10, wherein the one or more processors are configured to:
concurrently communicate, via the transceiver, a first portion of the traffic via the supplemental uplink in the frequency band and a second portion of the traffic via a second uplink in a second frequency band higher than the frequency band.

12. The system of claim 10, wherein the one or more processors are configured to:
determine the characteristic comprising at least one of: a device characteristic of the wireless communication device, a usage characteristic of the wireless communication device, or traffic stored in a buffer of the wireless communication device; and
select the frequency band from a plurality of frequency bands according to the characteristic.

13. The system of claim 10, wherein the one or more processors are configured to:
identify a plurality of frequency bands as candidates for the supplemental uplink;
perform a ranking of the plurality of frequency bands according to the characteristic; and
identify the frequency band from the plurality of frequency bands according to the ranking.

14. The system of claim 10, wherein the one or more processors are configured to:
transmit, via the transceiver to the wireless communication node, the first message identifying the frequency band and the second frequency band;
receive, via the transceiver from the wireless communication node responsive to the first message and in accordance with a network optimization criterion by the wireless communication node, the configuration for the supplemental uplink in accordance with the frequency band.

15. The system of claim 10, wherein the one or more processors are configured to:
transmit, via the transceiver, the first message via a first radio resource control (RRC) message comprising characteristics of the network traffic to be communicated via the supplemental uplink; and
receive, via the transceiver, the second message comprising one of a second RRC message or a downlink control information (DCI) message.

16. The system of claim 10, wherein the one or more processors are configured to:
receive, via the transceiver from the wireless communication node via one of a radio resource control (RRC) message or a downlink control information (DCI) message, one or more frequency bands supported by the wireless communication node; and
select, according to the characteristic, the frequency band from the one or more frequency bands.

17. The system of claim 10, wherein the one or more processors are configured to:
detect a change in the characteristic of the wireless communication device;
identify, responsive to the change, a second frequency band for communicating via the supplemental uplink;
transmit, via the transceiver to the wireless communication node, a third message comprising an identification of the second frequency band and a second request to access the second frequency band for communicating via the supplemental uplink; and
receive, via the transceiver from the wireless communication node responsive to the third message, a fourth message comprising a second configuration for the supplemental uplink wireless communication in accordance with the second frequency band.

18. The system of claim 10, wherein the one or more processors are configured to:
detect that an antenna of the wireless communication device has a first efficiency for the frequency band and a second efficiency for a second frequency band; and
transmit, via the transceiver to the wireless communication node, the first message comprising the request responsive to the first efficiency being greater than the second efficiency.

19. A non-transitory computer readable medium storing program instructions for causing at least one processor of a wireless communication device to:
identify, according to a characteristic of the wireless communication device for wireless communication, a frequency band for communicating via a supplemental uplink;
transmit, via the transceiver to a wireless communication node, a first message comprising an identification of the frequency band and a request to access the frequency band for communicating via the supplemental uplink;
receive, via the transceiver from the wireless communication node responsive to the first message, a second message comprising a configuration for the supplemental uplink corresponding to the frequency band; and
communicate traffic via the supplemental uplink in the frequency band, according to the configuration.

20. The non-transitory computer readable medium of claim 19, wherein the program instructions can be configured to cause the at least one processor to:
determine the characteristic comprising at least one of: a device characteristic of the wireless communication device, a usage characteristic of the wireless communication device, or traffic stored in a buffer of the wireless communication device;
select the frequency band from a plurality of frequency bands according to the characteristic; and
concurrently communicate, via the transceiver, a first portion of the traffic via the supplemental uplink in the frequency band and a second portion of the traffic via a second uplink in a second frequency band higher than the frequency band.
